(19) United States
(12) Patent Application Publication
(10) Pub. No.: US 2006/0282255 A1
(43) Pub. Date: Dec. 14, 2006

(54) Collocation translation from monolingual and available bilingual corpora

(75) Inventors: Yajuan Lu, Beijing (CN); Jianfeng Gao, Beijing (CN); Ming Zhou, Beijing (CN); John T. Chen, Beijing (CN); Mu Li, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/152,540

(22) Filed: Jun. 14, 2005

(51) Int. Cl. G06F 17/28

(52) U.S. Cl. 704/2

(57) ABSTRACT

A system and method of extracting collocation translations is presented. The methods include constructing a collocation translation model using monolingual source and target language corpora as well as bilingual corpus, if available. The collocation translation model employs an expectation maximization algorithm with respect to contextual words surrounding collocations. The collocation translation model can be used later to extract a collocation translation dictionary. Optional filters based on context redundancy and/or bi-directional translation constrain can be used to ensure that only highly reliable collocation translations are included in the dictionary. The constructed collocation translation model and the extracted collocation translation dictionary can be used later for further natural language processing, such as sentence translation.

### BACKGROUND OF THE INVENTION

The present invention generally relates to natural language processing. More particularly, the present invention relates to collocation translation.

A dependency triple is a lexically restricted word pair with a particular syntactic or dependency relation and has the general form: <w₁, r, w₂>, where w₁ and w₂ are words, and r is the dependency relation. For instance, a dependency triple such as <turn on, OBJ, light> is a verb-object dependency triple. There are many types of dependency relations between words found in a sentence, and hence, many types of dependency triples. A collocation is a type of dependency triple where the individual words w₁ and w₂, often referred to as the “head” and “dependent”, respectively, meet or exceed a selected relatedness threshold. Common types of collocations include subject-verb, verb-object, noun-adjective, and verb-adverb collocations.

It has been observed that although there can be great differences between a source and target language, strong correspondences can exist between some types of collocations in a particular source and target language. For example, Chinese and English are very different languages but nonetheless there exists a strong correspondence between subject-verb, verb-object, noun-adjective, and verb-adverb collocations. Strong correspondence in these types of collocations makes it desirable to use collocation translations to translate phrases and sentences from the source to target language. In this way, collocation translations are important for machine translation, cross language information retrieval, second language learning, and other bilingual natural language processing applications.

Collocation translation errors often occur because collocations can be idiosyncratic, and thus, have unpredictable translations. In other words, collocations in a source language can have similar structure and semantics relative to one another but quite different translations in both structure and semantics in the target language.

For example, suppose the Chinese verb “kan4” is considered the head of a Chinese verb-object collocation. The word “kan4” can be translated into English as “see,” “watch,” “look,” or “read” depending on the object or dependant with which “kan4” is collocated. For example, “kan4” can be collocated with the Chinese word “dian4ying3,” (which means film or movie in English) or “dian4shi4,” which usually means “television” in English. However, the Chinese collocations “kan4 dian4ying3” and “kan4dian4shi4,” depending on the sentence, may be best translated into English as “see film,” and “watch television,” respectively. Thus, the word “kan4” is translated differently into English even though the collocations “kan4 dian4ying3,” and “kan4 dian4shi4,” have similar structure and semantics.

In another situation, “kan4” can be collocated with the word “shul,” which usually means “book” in English. However, the collocation “kan4 shul” in many sentences can be best translated simply as “read” in English, and hence, the object “book” is dropped altogether in the collocation translation.

It is noted that Chinese words are herein expressed in “Pinyin,” with tones expressed as digits following the romanized pronunciation. Pinyin is a commonly recognized system of Mandarin Chinese pronunciation.

In the past, methods of collocation translation have usually relied on parallel or bilingual corpora of a source and target language. However, large aligned bilingual corpora are generally difficult to obtain and expensive to construct. In contrast, larger monolingual corpora can be more readily obtained for both source and target languages.

More recently, methods of collocation translation using monolingual corpora have been developed. However, these methods have generally not also included using bilingual corpora that might be available or available in limited quantities. Further, these methods that use monolingual corpora have generally not taken into consideration contextual words surrounding the collocations being translated.

Accordingly, there is a continued need for improved methods of collocation translation and extraction for various natural language processing applications.

### SUMMARY OF THE INVENTION

The present inventions include constructing a collocation translation model using monolingual corpora and available bilingual corpora. The collocation translation model employs an expectation maximization algorithm with respect to contextual words surrounding the collocations being translated. In other embodiments, the collocation translation model is used to identify and extract collocation translations. In further embodiments, the constructed translation model and the extracted collocation translations are used for sentence translation.

### BRIEF DESCRIPTION OF THE DRAWINGS

FIG. 1 is a block diagram of one computing environment in which the present invention can be practiced.

FIG. 2 is an overview flow diagram illustrating three aspects of the present invention.

FIG. 3 is a block diagram of a system for augmenting a lexical knowledge base with probability information useful for collocation translation.

FIG. 4 is a block diagram of a system for further augmenting the lexical knowledge base with extracted collocation translations.

FIG. 5 is a block diagram of a system for performing sentence translation using the augmented lexical knowledge base.

FIG. 6 is a flow diagram illustrating augmentation of the lexical knowledge base with probability information useful for collocation translation.

FIG. 7 is a flow diagram illustrating further augmentation of the lexical knowledge base with extracted collocation translations.

FIG. 8 is a flow diagram illustrating using the augmented lexical knowledge base for sentence translation.

### DETAILED DESCRIPTION OF ILLUSTRATIVE EMBODIMENTS

Automatic collocation translation is an important technique for natural language processing, including machine translation and cross-language information retrieval.

One aspect of the present invention provides for augmenting a lexical knowledge base with probability information useful in translating collocations. In anther aspect, the present invention includes extracting collocation translations using the stored probability information to further augment the lexical knowledge base. In another aspect, the obtained lexical probability information and the extracted collocation translations are used later for sentence translation.

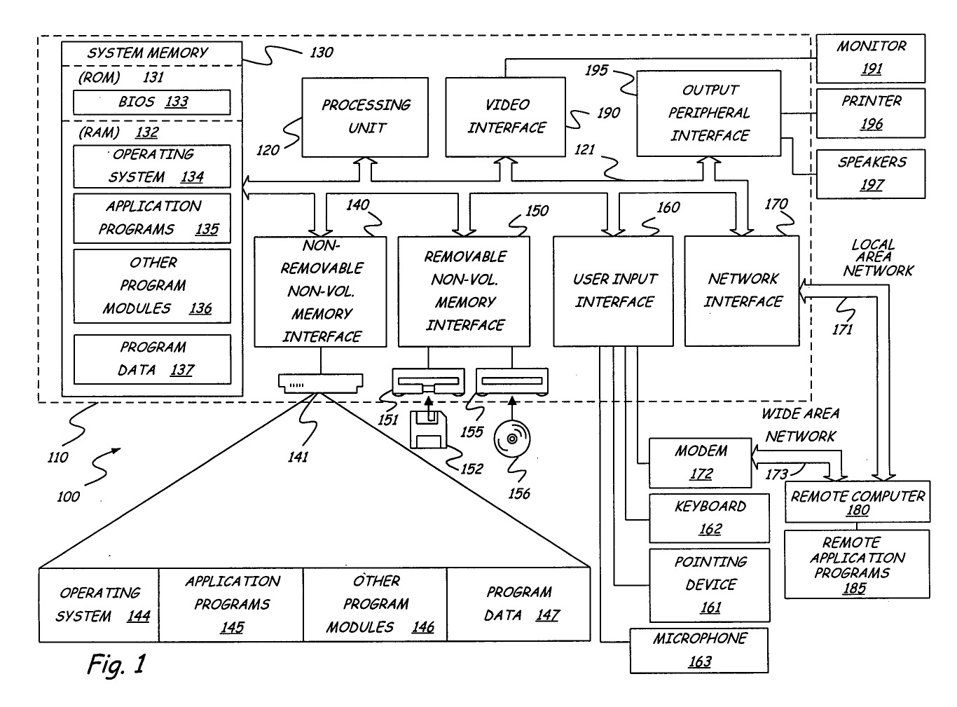

Before addressing further aspects of the present invention, it may be helpful to describe generally computing devices that can be used for practicing the invention. FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephone systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and figures provided herein as processor executable instructions, which can be written on any form of a computer readable medium.

The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

Background Collocation Translation Models

Collocation translation models have been constructed according to Bayes's theorem. Given a source language (e.g. Chinese) collocation or triple cₜᵣᵢ=(c₁,r_{c},c₂), and the set of its candidate target language (e.g. English) triple translations eₜᵣᵢ=(e₁,rₑ,e₂), the best English triple êₜᵣᵢ=(ê₁,rₑ, ê₂) is the one that maximizes the following equation. Equation (1):

$$\begin{matrix}{\hat{e}}_{tri} = {arg max}_{{e}_{tri}} p ( {e}_{tri} \vert {c}_{tri} ) \\ = {arg max}_{{e}_{tri}} p ( {e}_{tri} ) p ( {c}_{tri} \vert {e}_{tri} ) / p ( {c}_{tri} ) \\ = {arg max}_{{e}_{tri}} p ( {e}_{tri} ) p ( {c}_{tri} \vert {e}_{tri} )\end{matrix} \qquad Eq . 1$$

where p(eₜᵣᵢ) has been called the language or target language model and p(cₜᵣᵢ|eₜᵣᵢ) has been called the translation or collocation translation model. It is noted that for convenience, collocation and triple are used interchangeably. In practice, collocations are often used rather than all dependency triples to limit size of training corpora.

The target language model p(eₜᵣᵢ) can be calculated with an English collocations or triples database. Smoothing such as by interpolation can be used to mitigate problems associated with data sparseness as described in further detail below.

The probability of a given English collocation or triple occurring in the corpus can be calculated as follows:

$$p ( {e}_{tri} ) = \frac{freq ( {e}_{1} , {r}_{e} , {e}_{2} )}{N} \qquad Eq . 2$$

where freq(e₁,rₑ,e₂) represents the frequency of triple eₜᵣᵢ and N represents the total counts of all the English triples in the training corpus. For an English triple eₜᵣᵢ=(e₁,rₑ,e₂), if two words e₁ and e₂ are assumed to be conditionally independent given the relation rₑ, Equation (2) can be rewritten as follows:

$$p ( {e}_{tri} ) = p ( {r}_{e} ) p ( {e}_{1} \vert {r}_{e} ) p ( {e}_{2} \vert {r}_{e} ) \\ where \\ p ( {r}_{e} ) = \frac{freq (* , {r}_{e} , *)}{N} , \\ p ( {e}_{1} \vert {r}_{e} ) = \frac{freq ( {e}_{1} , {r}_{e} , *)}{freq (* , {r}_{e} , *)} , \\ p ( {e}_{2} \vert {r}_{e} ) = \frac{freq (* , {r}_{e} , {e}_{2} )}{freq (* , {r}_{e} , *)} . \qquad Eq . 3$$

The wildcard symbol * symbolizes any word or relation. With Equations (2) and (3), the interpolated language model is as follows:

$$p ( {e}_{tri} ) = α \frac{freq ( {e}_{tri} )}{N} + ( 1 - α ) p ( {r}_{e} ) p ( {e}_{1} \vert {r}_{e} ) p ( {e}_{2} \vert {r}_{e} ) \qquad Eq . 4$$

where O<α<1. The smoothing factor a can be calculated as follows:

$$α = 1 - \frac{1}{1 + freq ( {e}_{tri} )} \qquad Eq . 5$$

The translation model p(cₜᵣᵢ|eₜᵣᵢ) of Equation 1 has been estimated using the following two assumptions.

Assumption 1: Given an English triple eₜᵣᵢ, and the corresponding Chinese dependency relation r_{c}, c₁, and c₂ are conditionally independent, which can be expressed as follows:

$$\begin{matrix}p ( {c}_{tri} \vert {e}_{tri} ) = p ( {c}_{1} , {r}_{c} , {c}_{2} \vert {e}_{tri} ) \\ = p ( {c}_{1} \vert {r}_{c} , {e}_{tri} ) p ( {c}_{2} \vert {r}_{c} , {e}_{tri} ) p ( {r}_{c} \vert {e}_{tri} )\end{matrix} \qquad Eq . 6$$

Assumption 2: For an English triple eₜᵣᵢ, assume that cᵢ only depends on eᵢ(iεE{1,2}), and r_{c} only depends on rₑ. Equation (6) can then be rewritten as follows:

$$\begin{matrix}p ( {c}_{tri} \vert {e}_{tri} ) = p ( {c}_{1} \vert {r}_{c} , {e}_{tri} ) p ( {c}_{2} \vert {r}_{c} , {e}_{tri} ) p ( {r}_{e} \vert {e}_{tri} ) \\ = p ( {c}_{1} \vert {e}_{1} ) p ( {c}_{2} \vert {e}_{2} ) p ( {r}_{c} \vert {r}_{e} )\end{matrix} \qquad Eq . 7$$

It is noted that p(c₁|e₁) and p(c₂|e₂) are translation probabilities within triples; and thus, they are not unrestricted probabilities. Below, the translation between head (p(c₁|e₁)) and dependant (p(c₂|e₂)) are expressed as p_{head}(c|e) and p_{dep}(c|e), respectively.

As the correspondence between the same dependency relation across English and Chinese is strong, for convenience, it can be assumed that p(r_{c}|rₑ)=1for the corresponding rₑ and r_{c}, and p(r_{c}|rₑ)=0 for the other cases. In other embodiments p(r_{c}|rₑ) ranges from 0.8 and 1.0 and p(r_{c}|rₑ) correspondingly ranges from 0.2 to 0.0.

The probability values p_{head}(c₁|e₁) and p_{dep}(c₂|e₂) have been estimated iteratively using the expectation maximization (EM) algorithm described in “Collocation translation acquisition using monolingual corpora,” by Yajuan Lü and Ming Zhou, The 42^{nd} Annual Meeting of the Association for Computational Linguistics, pp. 295-302, 2004. In Lü and Zhou (2004), the EM algorithm was presented as follows:

$$E \text{-} step \text{:} p ( {e}_{tri} \vert {c}_{tri} ) ← \frac{p ( {e}_{tri} ) {p}_{head} ( {c}_{1} \vert {e}_{1} ) {p}_{dep} ( {c}_{2} \vert {e}_{2} ) p ( {r}_{c} \vert {r}_{e} )}{{\sum }_{{e}_{tri} = ( {e}_{1} , {r}_{e} , {e}_{2} ) ∈ ETri}^{} p ( {e}_{tri} ) {p}_{head} ( {c}_{1} \vert {e}_{1} ) {p}_{dep} ( {c}_{2} \vert {e}_{2} ) p ( {r}_{c} \vert {r}_{e} )} \\ M \text{-} step \text{:} {p}_{head} ( c \vert e ) = \frac{{\sum }_{{e}_{tri} = ( e , * , *)}^{} {\sum }_{{c}_{tri} = ( c , * , *)}^{} p ( {c}_{tri} ) p ( {e}_{tri} \vert {c}_{tri} )}{{\sum }_{{e}_{tri} = ( e , * , *)}^{} {\sum }_{{c}_{tri} ∈ CTri}^{} p ( {c}_{tri} ) p ( {e}_{tri} \vert {c}_{tri} )} \\ {p}_{dep} ( c \vert e ) = \frac{{\sum }_{{e}_{tri} = (* , * , e )}^{} {\sum }_{{c}_{tri} = (* , * , c )}^{} p ( {c}_{tri} ) p ( {e}_{tri} \vert {c}_{tri} )}{{\sum }_{{e}_{tri} = (* , * , e )}^{} {\sum }_{{c}_{tri} ∈ CTri}^{} p ( {c}_{tri} ) p ( {e}_{tri} \vert {c}_{tri} )}$$

where, ETri represents English triple set and CTri represents Chinese triple set.

The translation probabilities p_{head}(c|e) and p_{dep}(c|e) are initially set to a uniform distribution as follows:

$${p}_{head} ( c \vert e ) = {p}_{dep} ( c \vert e ) = \{ \begin{matrix}\frac{1}{\vert {Γ}_{e} \vert} , & if ( c ∈ {Γ}_{e} ) \\ 0 , & otherwise\end{matrix} \qquad Eq . 8$$

where Γₑ represents the translation set of the English word e. The word translation probabilities are estimated iteratively using the above EM algorithm.
Present Collocation Translation Model

The present framework includes log linear modeling for collocation translation model. Included in the present model are aspects of the collocation translation model described in La and Zhou (2004). However, the present model also exploits contextual information from contextual words surrounding collocations being translated. Additionally, the present framework integrates both bilingual corpus based features and monolingual corpus based features, when available or desired.

Given a Chinese collocation c_{col}=(c₁,r_{c},c₂), and the set of its candidate English translations e_{col}=(e₁,rₑ,e₂), the translation probability can be estimated as:

$$\begin{matrix}p ( {e}_{col} \vert {c}_{col} ) = {p}_{{λ}_{1}^{M}} ( {e}_{col} \vert {c}_{col} ) \\ = \frac{exp [ {\sum }_{m = 1}^{M} {λ}_{m} {h}_{m} ( {e}_{col} , {c}_{col} ) ]}{{\sum }_{{e}_{col}^{′}}^{} exp [ {\sum }_{m = 1}^{M} {λ}_{m} {h}_{m} ( {e}_{col}^{′} , {c}_{col} ) ]}\end{matrix} \qquad Eq . 9$$

where, hₘ(e_{col},c_{col}),m=1, . . . M is a set of feature functions. It is noted that the present translation model can be constructed using collocations rather than only dependency triples. For each feature function hₘ, there exists a model parameter λₘ,m=1, . . . , M. Given a set of features, the parameter λₘ can be estimated using the IIS or GIS algorithm described in “Discriminative training and maximum entropy models for statistical machine translation,” by Franz Josef Osch and Hermann Ney, The 40^{th} Meeting of the Association for Computational Linguistics, pp. 295-302 (2002).

The decision rule to choose the most probable English translation is:

$$\begin{matrix}{\hat{e}}_{col} = {arg max}_{{e}_{col}} \{ p ( {e}_{col} \vert {c}_{col} ) \} \\ = {arg max}_{{e}_{col}} \{ {p}_{{λ}_{1}^{M}} ( {e}_{col} \vert {c}_{col} ) \} \\ = {arg max}_{{e}_{col}} \{ \frac{exp [ {\sum }_{m = 1}^{M} {λ}_{m} {h}_{m} ( {e}_{col} , {c}_{col} ) ]}{{\sum }_{{e}_{col}^{′}}^{} exp [ {\sum }_{m = 1}^{M} {λ}_{m} {h}_{m} ( {e}_{col}^{′} , {c}_{col} ) ]} \} \\ = {arg max}_{{e}_{col}} \{ {\sum }_{m = 1}^{M} {λ}_{m} {h}_{m} ( {e}_{col} , {c}_{col} ) \}\end{matrix} \qquad Eq . 10$$

In the present translation model, at least three kinds of feature functions or scores are considered: target language score, inside-collocation translation score, and contextual word translation score as described in further detail below.
Feature Function Attributed to Target Language Score

In the present inventions, the target language feature function is defined as:
h₁(e_{col},c_{col})=log p(e_{col}) Eq. 11
where, p(e_{col}) as above is usually called the target language model. The target language model can be estimated using the target or English language corpus as described with respect to the background collocation translation model.
Feature Functions Attributed to Inside-Collocation Translation Scores

Inside-collocation translation scores can be expressed as the following word translation probabilities:
h₂(e_{col},c_{col})=log p(e₁|c₁) Eq. 12
h₃(e_{col},c_{col})=log p(e₂|c₂) Eq. 13
h₄(e_{col},c_{col})=log p(c₁|e₁) Eq. 14
h₅(e_{col},c_{col})=log p(c₂|e₂) Eq. 15
It is noted that in alternative embodiments the feature functions h₄ and h₅ can be omitted. The inverted word translation probabilities p(cᵢ|eᵢ), i=1, 2 has been called the translation model in the source channel model for machine translation. Experiments have indicated that the direct probabilities p(eᵢ|cᵢ), i=1, 2 generally yield better results in collocation translation. In the present inventions, the direct probabilities p(eᵢ|cᵢ), are included as feature functions in the collocation translation model.

Following the methods described in Lü and Zhou (2004), the collocation word translation probabilities can be estimated using two monolingual corpora. It is assumed that there is a strong correspondence of the three main dependency relations between English and Chinese: verb-object, noun-adjective, verb-adverb. An EM algorithm, together with a bilingual translation dictionary, is then used to estimate the four inside-collocation translation probabilities h₂ to h₅ in Equations 12 to 15. It is noted that h₄ and h₅ can be derived directly from Lü and Zhou (2004) and that h₂ and h₃ can be derived similarly by using English as the source language and Chinese as the target language and then applying the EM algorithm described therein.

In addition, a relation translation score can also be considered as a feature function in present model as expressed below:
h₆(e_{col},c_{col})=log p(rₑ|r_{c}) Eq. 16
Similar to Lü and Zhou (2004), it can be assumed that p(rₑ|r_{c})=0.9 for the corresponding rₑ and r_{c}, and p(rₑ|r_{c})=0.1 for the other cases. In other embodiments p(rₑ|r_{c}) ranges from 0.8 and 1.0 for the corresponding rₑ and r_{c}, and p(rₑ|r_{c}) correspondingly ranges from 0.2 to 0.0 otherwise. In still other embodiments, feature function h₆ is altogether omitted.
Feature Functions Attributed to Contextual Word Translation Scores

In the present collocation translation model, contextual words outside a collocation are also useful for collocation translation disambiguation. For example, in the sentence “ [symbol] — [symbol] (I saw an interesting film at the cinema)”, to translate the collocation “ [symbol] (saw)˜ [symbol] (film)”, the contextual words “ [symbol] (cinema)” and “ [symbol] (interesting)” are also helpful in translation. The contextual word feature functions can be expressed as follows:
h₇(e_{col},c_{col})=log p_{c}_{₁}(e₁|D₁) Eq. 17
h₈(e_{col},c_{col})=log p_{c}_{₂}(e₂|D₂) Eq. 18
where, D₁ is the contextual word set of c₁ and D₂ is the contextual word set of c₂. Here, c₂ is considered a context of c₁, and c₁ as a context of c₂. That is:
D₁={c₁′₋ₘ, . . . c₁′₋₁,c₁′ₘ}∪c₂
D₂={c₂′₋ₘ, . . . , c₂′₋₁, c₂′₁, . . . ,c₂′m}∪c₁
where, m is the window size.

For brevity, the word to be translated is denoted as c(c=c₁,or c=c₂), e is the candidate translation of c, and D=(c′₁, . . . ,c′ₙ) is the context of c. With the Naive Bayes assumption, it can be simplified as follows:

$$\begin{matrix}p ( e , D ) = p ( e , {c}_{1}^{′} , … {c}_{n}^{′} ) \\ = p ( e ) p ( {c}_{1}^{′} , … {c}_{n}^{′} \vert e ) \\ \approx p ( e ) {\prod }_{{c}^{′} ∈ \{ {c}_{1}^{′} , … , {c}_{n}^{′} \}}^{} p ( {c}^{′} \vert e )\end{matrix} \qquad Eq . 19$$

Values of p(e) can be estimated easily with an English corpus. Since the prior probability p_{c}(e)=p(e|c) has been considered in inside-collocation translation feature functions, here only the second component in contextual word translation scores calculation is considered. That is:

$$\begin{matrix}{h}_{7} ( {e}_{col} , {c}_{col} ) = {\sum }_{{c}^{′} ∈ {D}_{1}}^{} log p ( {c}^{′} \vert {e}_{1} ) & Eq . 20 \\ {h}_{8} ( {e}_{col} , {c}_{col} ) = {\sum }_{{c}^{′} ∈ {D}_{2}}^{} log p ( {c}^{′} \vert {e}_{2} ) . & Eq . 21\end{matrix}$$

Now, the problem is how to estimate the translation probability p(c′|e). Traditionally, it can be estimated using a bilingual corpus. In the present inventions a method is provided to estimate this probability using monolingual corpora.
Estimating Contextual Word Translation Probability Using Monolingual Corpora

The basic idea is that the Chinese context c′ is mapped into corresponding English context e′ with the assumption that all the instances (e′,e) in English are independently generated according to the distribution

$$p ( {e}^{′} \vert e ) = {\sum }_{{c}^{′} ∈ C}^{} p ( {c}^{′} \vert e ) p ( {e}^{′} \vert {c}^{′} , e ) .$$

In this way, the translation probability p(c′|e) can be estimated from an English monolingual corpus with the EM algorithm as below:

$$\begin{matrix}E \text{-} step \text{:} p ( {c}^{′} \vert {e}^{′} , e ) ← \frac{p ( {c}^{′} \vert e ) p ( {e}^{′} \vert {c}^{′} , e )}{{\sum }_{{c}^{′} ∈ C}^{} p ( {c}^{′} \vert e ) p ( {e}^{′} \vert {c}^{′} , e )} \\ M \text{-} step \text{:} p ( {e}^{′} \vert {c}^{′} , e ) ← \frac{f ( {e}^{′} , e ) p ( {c}^{′} \vert {e}^{′} , e )}{{\sum }_{{e}^{′} ∈ E}^{} f ( {e}^{′} , e ) p ( {c}^{′} \vert {e}^{′} c , e )} . \\ p ( {c}^{′} \vert e ) ← \frac{{\sum }_{{e}^{′} ∈ E}^{} f ( {e}^{′} , e ) p ( {c}^{′} \vert {e}^{′} , e )}{{\sum }_{{e}^{′} ∈ E}^{} f ( {e}^{′} , e )} \\ Initially , \\ \\ & \\ p ( {e}^{′} \vert {c}^{′} , e ) = \{ \begin{matrix}\frac{1}{\vert {T}_{c} \vert} , & if {e}^{′} ∈ {T}_{{c}^{′}} , \\ 0 , & if {e}^{′} ∉ {T}_{{c}^{′}}\end{matrix} \\ p ( {c}^{′} \vert e ) = \frac{1}{\vert C \vert} , {c}^{′} ∈ C & Eq . 22\end{matrix}$$

where, C denotes Chinese word set, E denotes English word set, and T_{c} denotes the translation set of the Chinese word c. The use of the EM algorithm can help to accurately transform the context from one language to another.

In some embodiments, to avoid zero probability, p(c′|e) can be smoothed with a prior probability p(c′) such that
p(c′|e)=αp′(c′|e)+(1−αa)p(c′) Eq. 23
where p′(c′|e) is the probability estimated by the EM algorithm described above, parameter α can be set to 0.8 per experiments, but similar values is can also be used.
Integrating Bilingual Corpus Derived Features Into Collocation Translation Model

For certain source and target language pairs (e.g. English and Spanish), some bilingual corpora is available. The present collocation translation framework can integrate these valuable bilingual resources into the same collocation translation model.

Since all translation features in the present collocation translation model can also be estimated using a bilingual corpus, corresponding bilingual corpus derived features can be derived relatively easily. For example, bilingual translation probabilities can be defined as follows:
h₉(e₁,c_{col})=log p_{bi}(e₁|c₁) Eq. 24
h₁₀(e_{col},c_{col})=log p_{bi}(e₂|c₂) Eq. 25
h₁₁(e_{col},c_{col})=log p_{bi}(c₁|e₁) Eq. 26
h₁₂(e_{col},c_{col})=log p_{bi}(c₂|e₂) Eq. 27
h₁₃(e_{col},c_{col})=log p_{bi}(e₁|D₁) Eq. 28
h₁₄(e_{col},c_{col})=log p_{bi}(e₂|D₂) Eq. 29
These probability values or information can be estimated from bilingual corpora using previous methods such as the IBM model described in, “The mathematics of machine translation: parameter estimation,” by Brown et al., Computational Linguistics, 19(2): pp. 263-313 (1993).

Generally, it is useful to use bilingual resources when available. Bilingual corpora can improve translation probability estimation, and hence, the accuracy of collocation translation. The present modeling framework is advantageous at least because it seamlessly integrates both monolingual and available bilingual resources.

It is noted that in many embodiments, some feature functions described herein are omitted as not necessary to appropriately construct an appropriate collocation translation model. For example, in some embodiments, feature functions h₁₁ and h₁₂ are omitted as not necessary. In other embodiments, h₄ and h₅ are omitted. In still other embodiments, feature function h₆ based on dependency relation is omitted. Finally, in other embodiments feature functions h₄, h₅, h₆, h₁₁, and h₁₂ are omitted in the construction of collocation translation model.

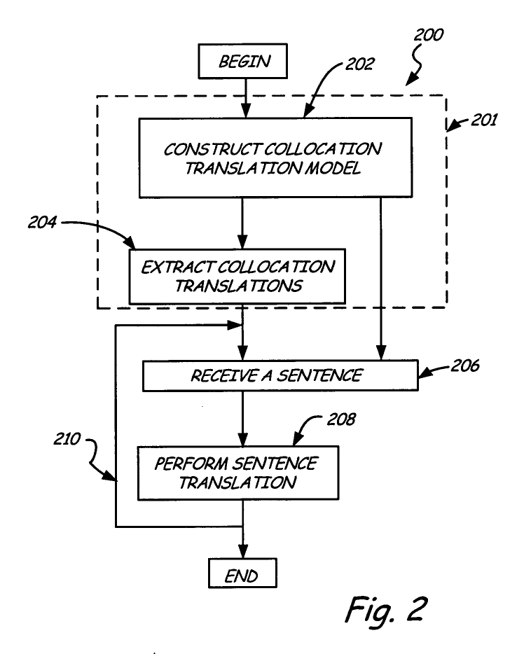

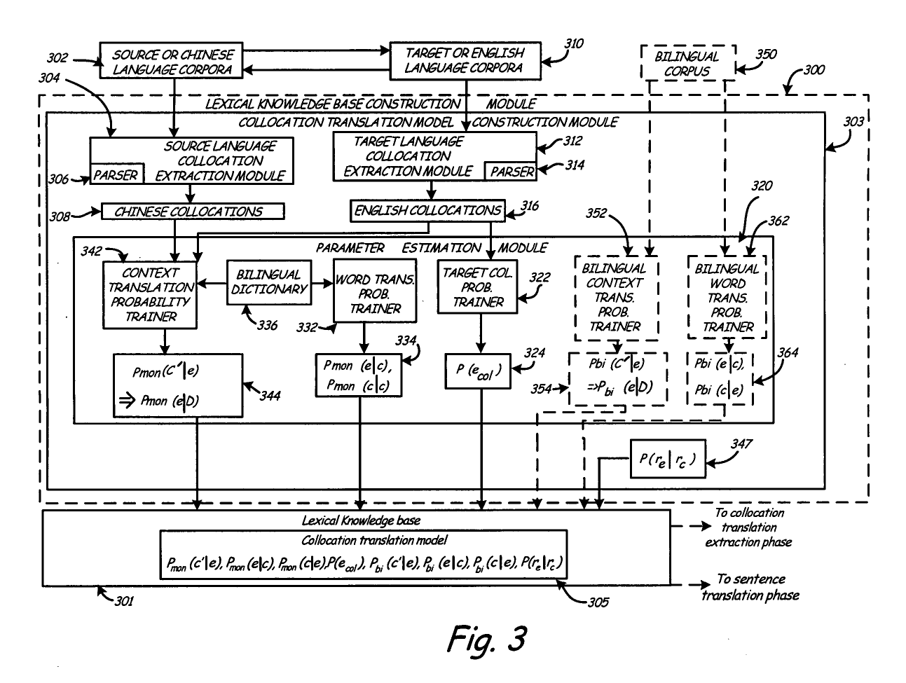

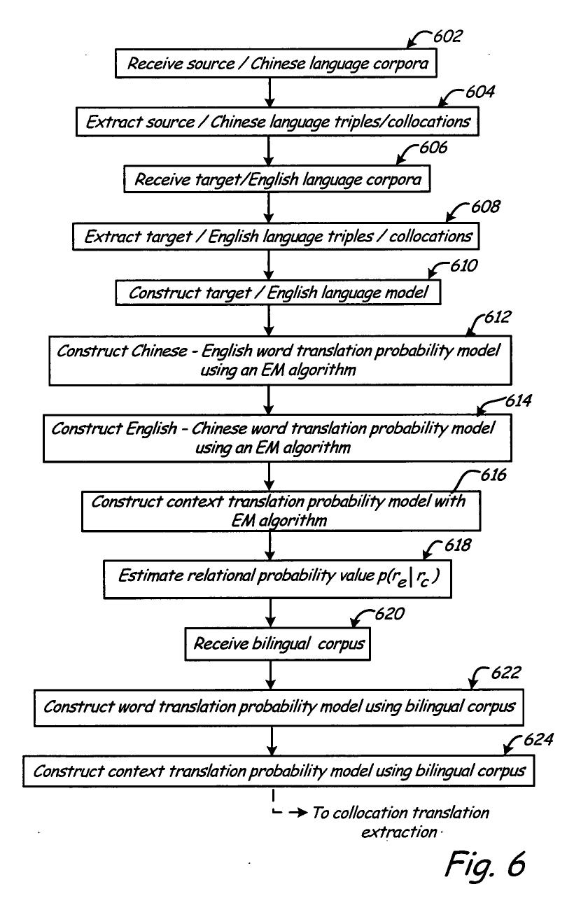

FIG. 2 is an overview flow diagram showing at least three general aspects of the present invention embodied as a single method 200. FIGS. 3, 4 and 5 are block diagrams illustrating modules for performing each of the aspects. FIGS. 6, 7, and 8 illustrate methods generally corresponding with the block diagrams illustrated in FIGS. 3, 4, and 5. It should be understood that the block diagrams, flowcharts, methods described herein are illustrative for purposes of understanding and should not be considered limiting. For instance, modules or steps can be combined, separated, or omitted in furtherance of practicing aspects of the present invention.

Referring now to FIG. 2, step 201 of method 200 includes augmenting a lexical knowledge base with information used later for further natural language processing, in particular, text or sentence translation. Step 201 comprises step 202 of constructing a collocation translation model in accordance with the present inventions and step 204 of using the collocation translation model of the present inventions to extract and/or acquire collocation translations. Method 200 further comprises step 208 of using both the constructed collocation translation model and the extracted collocation translations to perform sentence translation of a received sentence indicated at 206. Sentence translating can be iterative as indicated at 210.

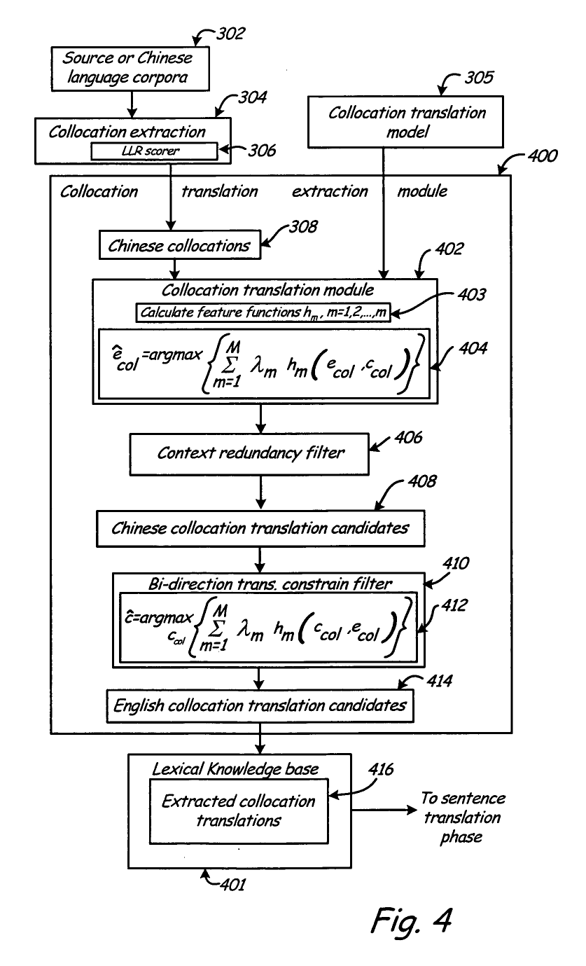

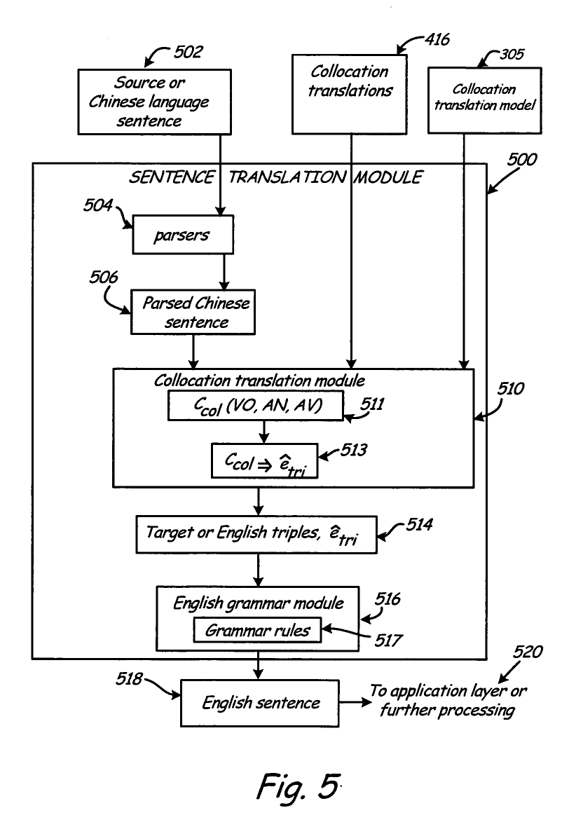

FIG. 3 illustrates a block diagram of a system comprising lexical knowledge base construction module 300. Lexical knowledge base construction module 300 comprises collocation translation model construction module 303, which constructs collocation translation model 305 in accordance with the present inventions. Collocation translation model 305 augments lexical knowledge base 301, which is used later in performing collocation translation extraction and sentence translation, such as illustrated in FIG. 4 and FIG. 5. FIG. 6 is a flow diagram illustrating augmentation of lexical knowledge base 301 in accordance with the present inventions and corresponds generally with FIG. 3.

Lexical knowledge base construction module 300 can be an application program 135 executed on computer 110 or stored and executed on any of the remote computers in the LAN 171 or the WAN 173 connections. Likewise, lexical knowledge base 301 can reside on computer 110 in any of the local storage devices, such as hard disk drive 141, or on an optical CD, or remotely in the LAN 171 or the WAN 173 memory devices. Lexical knowledge construction module 300 comprises collocation translation model construction module 303.

At step 602, Source or Chinese language corpus or corpora 302 are received by collocation translation model construction module 303. Source language corpora 302 can comprise text in any natural language. However, Chinese has often been used herein as the illustrative source language. In most embodiments, source language corpora 302 comprises unprocessed or pre-processed data or text, such as text obtained from newspapers, books, publications and journals, web sources, speech-to-text engines, and the like. Source language corpora 302 can be received from any of the input devices described above as well as from any of the data storage devices described above.

At step 604, source language collocation extraction module 304 parses Chinese language corpora 302 into dependency triples using parser 306 to generate Chinese collocations or collocation database 308. In many embodiments, collocation extraction module 304 generates source language or Chinese collocations 308 using for example a scoring system based on the Log Likelihood Ratio (LLR) metric, which can be used to extract collocations from dependency triples. Such LLR scoring is described in “Accurate methods for the statistics of surprise and coincidence,” by Ted Dunning, Computational Linguistics, 10(1), pp. 61-74 ((1993). In other embodiments, source language collocation extraction module 304 generates a larger set of dependency triples. In other embodiments, other methods of extracting collocations from dependency triples can be used, such as a method based on mutual word information (WMI).

At step 606, collocation translation model construction module 303 receives target or English language corpus or corpora 310 from any of the input devices described above as well as from any of the data storage devices described above. It is also noted that use of English is illustrative only and that other target languages can be used.

At step 608, target language collocation extraction module 312 parses English corpora 310 into dependency triples using parser 314. As above with module 304, collocation extraction module 312 can generate target or English collocations 316 using any method of extracting collocations from dependency triples. In other embodiments, collocation extraction 312 module can generate dependency triples without further filtering. English collocations or dependency triples 316 can be stored in a database for further processing.

At step 610, parameter estimation module 320 receives English collocations 316 and estimates language model p(e_{col}) with target or English collocation probability trainer 322 using any known method of estimating collocation language models. Target collocation probability trainer 322 estimates the probabilities of various collocations generally based on the count of each collocation and the total number of collocations in target language corpora 310, which is described in greater detail above. In many embodiments, trainer 322 estimates only selected types of collocations. As described above, verb-object, noun-adjective, and verb-adverb collocations have particularly high correspondence in the Chinese-English language pair. For this reason, embodiments of the present invention can limit the types of collocations trained to those that have high relational correspondence. Probability values 324 can be used to estimate feature function h₁as described above.

At step 612, parameter estimation module 320 receives Chinese collocations 308, English collocations 316, and bilingual dictionary (e.g. Chinese-to-English) and estimates word translation probabilities 334 using word translation probability trainer 332. In most embodiments, word translation probability trainer 332 uses the EM algorithm described in Lü and Zhou (2004) to estimate the word translation probability model using monolingual Chinese and English corpora. Such probability values pₘₒₙ(e|c) are used to estimate feature functions h₄ and h₅ described above.

At step 614, the original source and target languages are reversed so, for example, English is considered the source language and Chinese is the target language. Parameter estimation module 320 receives the reversed source and target language collocations and estimates the English-Chinese word translation probability model with the aid of an English-Chinese dictionary. Such probability values pₘₒₙ(c|e) are used to estimate feature functions h₂ and h₃ described above.

At step 616, parameter estimation module 320 receives Chinese collocations 308, English corpora 310, and bilingual dictionary 336 and constructs context translation probability model 342 using an EM algorithm in accordance with the present inventions described above. Probability values p(c′|e₁) and p(c′|e₂) are estimated with the EM algorithm and used to estimate feature functions h₇ and h₈ described above.

At step 618, a relational translation score or probability p(rₑ|r_{c}) indicated at 347 is estimated. Generally, it can be assumed that there is a strong correspondence between the same dependency relation in Chinese and English. Therefore, in most embodiments it is assumed that p(rₑ|r_{c})=0.9 if rₑ corresponds with rₑ, otherwise, p(rₑ|r_{c})=0.1. The assumed valued of p(rₑ|r_{c}) can be used to estimate feature function h₆. However, in other embodiments, the values of p(rₑ|r_{c}) can range from 0.8 to 1.0 if rₑ corresponds with rₑ, otherwise, 0.2 to 0, respectively.

At step 620, collocation translation model construction model 303 receives bilingual corpus 350. Bilingual corpus 350 is generally a parallel or sentence aligned source and target language corpus. At step 622, bilingual word translation probability trainer estimates probability values p_{bi}(c|e) indicated at 364. It is noted that target and source languages can be reversed to model probability values p_{bi}(e|c). The values of p_{bi}(c|e) and p_{bi}(e|c) can be used to estimate feature functions h₉ to h₁₂ as described above.

At step 624, bilingual context translation probability trainer 352 estimates values of p_{bi}(e₁|D₁) and p_{bi}(e₂|D₂). Such probability values can be used to estimate feature functions h₁₃ and h₁₄ described above.

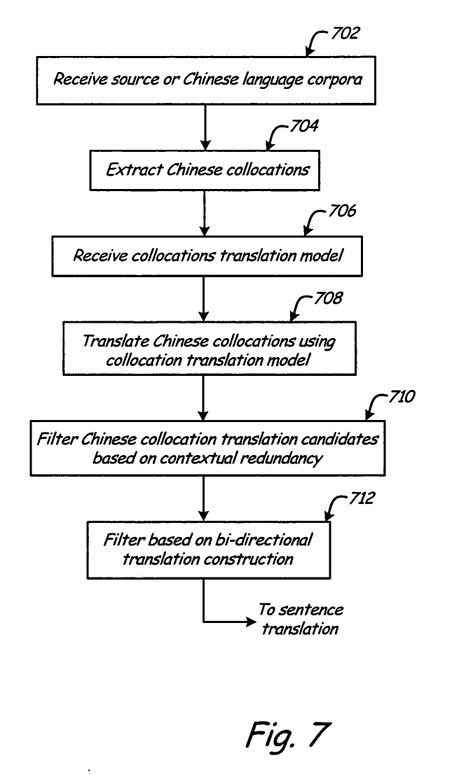

After all parameters are estimated, collocation translation model 305 can be used for online collocation translation. It can also be used for offline collocation translation dictionary acquisition. Referring now to FIGS. 2, 4, and 7, FIG. 4 illustrates a system, which performs step 204 of extracting collocation translations to further augment lexical knowledge base 201 with a collocation translation dictionary of a particular source and target language pair. FIG. 7 corresponds generally with FIG. 4 and illustrates using lexical collocation translation model 305 to extract and/or acquire collocation translations.

At step 702, collocation extraction module 304 receives source language corpora. At step 704, collocation extraction module 304 extracts source language collocations 308 from source language corpora 302 using any known method of extracting collocations from natural language text. In many embodiments, collocation extraction module 304 comprises Log Likelihood Ratio (LLR) scorer 306. LLR scorer 306 scores dependency triples cₜᵣᵢ=(c₁,r_{c},c₂) to identify source language collocations c_{col}=(c₁,r_{c},c₂) indicated at 308. In many embodiments, Log Likelihood Ratio (LLR) scorer 306 calculates LLR scores as follows:

$$\begin{matrix}Log l = a log a + b log b + c log c + d log d - ( a + b ) log ( a + b ) - \\ ( a + c ) log ( a + c ) - ( b + d ) log ( b + d ) - ( c + d ) log ( c + d ) + \\ N log N\end{matrix}$$

where, N is the total counts of all Chinese triples,
a=f(c₁,r_{c},c₂),
and b=f(c₁,r_{c},*)−f(c₁,r_{c},c₂),
c=f(*,r_{c},c₂)−f(c₁,r_{c},c₂),
d=N−a−b−c.
It is noted that f indicates counts or frequency of a particular triple and * is a “wildcard” indicating any Chinese word. Those dependency triples whose frequency and LLR values are larger than selected thresholds are identified and taken as source language collocation 308.

As described above, in many embodiments, only certain types of collocations are extracted depending on the source and target language pair being processed. For example, verb-object (VO), noun-adjective (AN), verb-adverb (AV) collocations can be extracted for the Chinese-English language pair. In one embodiment, the subject-verb (SV) collocation is also added. An important consideration in selecting a particular type of collocation is strong correspondence between the source language and one or more target languages. It is further noted that LLR scoring is only one method of determining collocations and is not intended to be limiting. Any known method for identifying collocations from among dependency triples can also be used (e.g. weighted mutual information (WMI).

At step 706, collocation translation extraction module 400 receives collocation translation model 305, which can comprise probability values Pₘₒₙ(c′|e), Pₘₒₙ(e|c), Pₘₒₙ(c|e), P(e_{col}), P_{bi}(c′|e), P_{bi}(e|c), P_{bi}(c|e), and P(rₑ|r_{c}), as described above.

At step 708, collocation translation module 402 translates Chinese collocations 308 into target or English language collocations. First, 403 calculate feature functions using the probabilities in collocation translation model. In most embodiments, feature functions have a log linear relationship with associated probability functions as described above. Then, 404 using collocation the calculated feature functions so that each Chinese collocation c_{col} among Chinese collocations 308 is translated into the most probable English collocation ê_{col} as indicated at 404 and below:

$${\hat{e}}_{col} = {arg max}_{{e}_{col}} \{ {\sum }_{m = 1}^{M} {λ}_{m} {h}_{m} ( {e}_{col} , {c}_{col} ) \}$$

In many embodiments, further filtering is performed to ensure that only highly reliable collocations translations are extracted. To this end, collocation translation extraction module 400 can comprise context redundancy filter 406 and/or bi-directional translation constrain filter 410. It is noted that a collocation may be translated into different translations in different contexts. For example, “ [symbol] ” or “kan4 dianlying3” (Pinyin) may receive several translations depending on different contexts, e.g. “see film”, “watch film”, and “look film”.

At step 710, context redundancy filter 406 filters extracted Chinese-English collocation pairs. In most embodiments, context redundancy filter 406 calculates the ratio of the highest frequency translation count to all translation counts. If the ratio meets a selected threshold, the collocation and the corresponding translation is taken as a Chinese collocation translation candidate as indicated at 408.

At step 712, bi-directional translation constrain filter 410 filters translation candidates 408 to generate extracted collocation translations 416 that can be used in a collocation translation dictionary for later processing. Step 712 includes extracting English collocation translation candidates as indicated at 412 with an English-Chinese collocation translation model. Such an English-Chinese translation model can be constructed from previous steps such as step 614 (illustrated in FIG. 6) where Chinese is considered the target language and English considered the source language. Those collocation translations that appear in both translation candidate sets 408, 414 are extracted as final collocation translations 416.

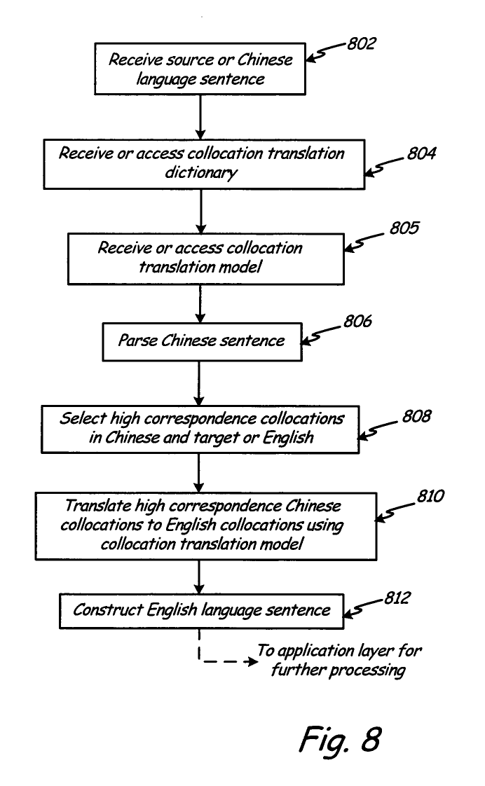

FIG. 5 is a block diagram of a system for performing sentence translation using the collocation translation dictionary and collocation translation model constructed in accordance with the present inventions. FIG. 8 corresponds generally with FIG. 5 and illustrates sentence translation using the collocation translation dictionary and collocation translation model of the present inventions.

At step 802, sentence translation module 500 receives source or Chinese language sentence through any of the input devices or storage devices described with respect to FIG. 1. At step 804, sentence translation module 500 receives or accesses collocation translation dictionary 416. At step 805, sentence translation module 500 receives or accesses collocation translation model 305. At step 806, parser(s) 504, which comprises at least a dependency parser, parses source language sentence 502 into parsed Chinese sentence 506.

At step 808, collocation translation module 500 selects Chinese collocations based on types of collocations having high correspondence between Chinese and the target or English language. In some embodiments, such types of collocations comprise verb-object, noun-adjective, and verb-adverb collocations as indicated at 511.

At step 810, collocation translation module 500 uses collocation translation dictionary 416 to translate Chinese collocations 511 to target or English language collocations 514 as indicated at block 513. At step 810, for those collocations of 511 that can not find translations using collocation translation dictionary, collocation translation module 500 uses collocation translation model 305 to translate these Chinese collocations to target or English language collocations 514. At step 812, English grammar module 516 receives English collocations 514 and constructs English sentence 518 based on appropriate English grammar rules 517. English sentence 518 can then be returned to an application layer or further processed as indicated at 520.

Although the present invention has been described with reference to particular embodiments, workers skilled in the art will recognize that changes may be made in form and detail without departing from the spirit and scope of the invention.

What is claimed is:

1. A computer readable medium including instructions readable by a computer which, when implemented, cause the computer to construct a collocation translation model comprising the steps of:
extracting source language collocations from monolingual source language corpora;
extracting target language collocations from monolingual target language corpora;
constructing a collocation translation model using at least the source and target language collocations, wherein the collocation language model is based on a set of feature functions, and wherein one of the feature functions comprises probability information for contextual words surrounding the extracted source language collocation.

2. The computer readable medium of claim 1, wherein the collocation translation model is based on a log linear relationship with at least some of the feature functions.

3. The computer readable medium of claim 1, wherein the contextual feature function estimates probability values using an expectation maximization algorithm.

4. The computer readable medium of claim 3, wherein the expectation maximization algorithm estimates parameters using monolingual source and target language corpora.

5. The computer readable medium of claim 1, wherein one of the feature functions comprises a target language collocation language model.

6. The computer readable medium of claim 1, wherein one of the feature functions comprises a word translation model of source to target language word translation probability information.

7. The computer readable medium of claim 1, wherein one of the feature functions comprises a word translation model of target to source language word translation probability information.

8. The computer readable medium of claim 1, and further comprising receiving bilingual corpus of the source and target language pair.

9. The computer readable medium of claim 8, wherein one of the feature functions comprises a word translation language model trained using the bilingual corpus.

10. The computer readable medium of claim 8, wherein one of the feature functions comprises a context translation model trained using the bilingual corpus.

11. The computer readable medium of claim 1, and further comprising the steps of:
receiving source language corpora parsing the source language corpora into source language dependency triples,
extracting the source language collocations from the parsed source language dependency triples;
accessing the collocation translation model to extract collocation translations corresponding to some of the extracted source language collocations.

12. The computer readable medium of claim 11, wherein the some of the extracted source language collocations are selected based on types of collocations having high correspondence between the source and the target languages.

13. A method of extracting collocation translations comprising the steps of:
receiving source language corpora;
receiving target language corpora;
extracting source language collocations from the source language corpora
modeling collocation translation probability information by estimating contextual word translation probability values for context words surrounding the extracted source language collocations using an expectation maximization algorithm.

14. The method of claim 13, wherein estimating contextual word probability values comprises selecting contextual words in a selected window size.

15. The method of claim 13, and further comprising the steps of:
receiving bilingual corpus in the source and target language pair;
estimating word translation probability values using the received bilingual corpus.

16. The method of claim 13, and further comprising extracting a collocation translation dictionary using the modeled collocation translation probability information.

17. The method of claim 16, wherein extracting the collocation translation dictionary further comprises filtering based on at least one of context redundancy and bi-directional translation constraints.

18. A system of extracting collocation translations comprising:
a module adapted to construct a source to target language collocation translation model, wherein the collocation translation model comprises probability values for a selected source language context that are estimated using iteration based on an expectation maximization algorithm.

19. The system of claim 18, and further comprising:
a second module adapted to extract a collocation translation dictionary using the collocation translation model, wherein the second module comprises a sub-module adapted to filter collocation translations based on context redundancy to generate collocation translation candidates.

20. The system of claim 19, wherein the second module further comprises a sub-module for filtering collocation translation candidates based on bi-directional constraints to generate a collocation translation dictionary.
